(19) United States
(12) Patent Application Publication
(10) Pub. No.: US 2023/0226734 A1
(43) Pub. Date: Jul. 20, 2023

(54) Cellulose Ester Composition and Process For Producing Articles Therefrom

(71) Applicant: Celanese International Corporation, Irving, TX (US)

(72) Inventors: Michael Combs, Shady Spring, WV (US); Denis Fallon, Blacksburg, VA (US); Joseph Grenci, Florence, KY (US)

(21) Appl. No.: 18/096,778

(22) Filed: Jan. 13, 2023

Related U.S. Application Data
(60) Provisional application No. 63/299,561, filed on Jan. 14, 2022.

(51) Int. Cl. B29C 48/00; C08L 1/12; C08K 5/103; C08L 71/02; C08K 5/07; C08K 5/06; C08J 3/12

(52) U.S. Cl. CPC B29C 48/022; C08L 1/12; C08K 5/103; C08L 71/02; C08K 5/07; C08K 5/06; C08J 3/12; C08L 2201/06; C08J 2301/12; B29K 2001/12

(57) ABSTRACT

A process is disclosed for combining a cellulose ester polymer with a plasticizer. The cellulose ester polymer is in the form of particles and is combined with a wetting agent and the plasticizer while mixing. The wetting agent dramatically improves the ability of the cellulose ester particles and plasticizer to form a homogeneous mixture. During melt processing, in one embodiment, the wetting agent is volatilized and does not remain in the final product.

### RELATED APPLICATIONS

The present application is based upon and claims priority to U.S. Provisional Patent Application Ser. No. 63/299,561, having a filing date of Jan. 14, 2022, which is incorporated herein by reference.

### BACKGROUND

Each year, the global production of plastics continues to increase. Over one-half of the amount of plastics produced each year are used to produce plastic bottles, containers, drinking straws, and other single-use items. The discarded, single-use plastic articles, including plastic drinking bottles, are typically not recycled and end up in landfills. In addition, many of these items are not properly disposed of and end up in streams, lakes, and oceans around the world.

In view of the above, those skilled in the art have attempted to produce plastic articles made from biodegradable polymers. Many biodegradable polymers, however, lack the physical properties and characteristics of conventional polymers, such as polypropylene and/or polyethylene terephthalate.

Cellulose esters have been proposed in the past as a replacement to some petroleum-based polymers or plastics. Cellulose esters, for instance, are generally considered environmentally friendly polymers because they are recyclable, degradable and derived from renewable resources, such as wood pulp. Problems have been experienced, however, in melt processing cellulose ester polymers, such as cellulose acetate polymers. The polymer materials are relatively stiff and have relatively poor elongation properties. In addition, the melt temperature of cellulose ester polymers is close to the degradation temperature of the polymer, which requires careful control over temperatures during melt processing. Consequently, cellulose esters are typically combined with a plasticizer in order to improve the melt processing properties of the material. Adding a plasticizer lowers the melt temperature of the composition preventing degradation.

One problem that has been experienced in the past, however, is being able to quickly and efficiently combine a plasticizer with a cellulose ester for producing a homogeneous composition. For example, many plasticizers do not easily mix with the cellulose ester particles. Failure to receive proper mixing of the two components can result in molded articles containing imperfections and non-uniform properties. Thus, in the past, in order to improve blending of cellulose ester particles with plasticizers, the cellulose ester particles have been dried in order to remove as much moisture as possible. In addition, the cellulose ester particles have been ground to very small sizes in order to increase surface area for contact with the plasticizer. Drying and grinding the cellulose ester particles, however, not only can add significant costs to the overall process but can also make it hard to handle and process the small particles.

In still other embodiments, cellulose ester particles and a plasticizer were premixed and stored prior to processing in order to improve blending. Although premixing the two components can provide some improvements, the premixing step not only requires significant amounts of time but also a significant amount of storage space.

In view of the above, a need exists for an improved process for combining cellulose ester polymers with plasticizers.

### SUMMARY

In general, the present disclosure is directed to a process for producing a polymer composition or polymer resin containing a cellulose acetate polymer in combination with at least one plasticizer. More particularly, the present disclosure is directed to a process by which cellulose ester particles are combined with a plasticizer in the presence of a wetting agent and then compounded into pellets. The pellets can then be used to produce all different types of polymer articles. Each pellet contains a cellulose ester polymer that is homogeneously blended with a plasticizer. By pre-compounding the plasticizer with the cellulose ester polymer, polymer articles can be produced having improved and more uniform properties. In addition, processing of the material can be completed efficiently without excess process steps. The resulting polymer composition is well suited for producing polymer articles, such as beverage holders, other plastic containers, drinking straws, hot beverage pods, automotive parts, consumer appliance parts, and the like.

As described above, in one aspect, the present disclosure is directed to a process for producing a cellulose ester product. The process can include combining cellulose ester particles with a plasticizer and a wetting agent. The cellulose ester polymer, plasticizer and wetting agent mixture are then melt processed into a plasticized cellulose ester product, such as pellets or any other suitable form. During melt processing, the wetting agent vaporizes. For example, in one embodiment, the wetting agent can be completely removed from the final product such that the final product contains the wetting agent in an amount less than about 1% by weight, such as in an amount less than about 0.01% by weight.

In accordance with the present disclosure, the wetting agent has been found to dramatically improve mixing between the plasticizer and cellulose ester particles. In one aspect, the wetting agent is a liquid having a boiling point of generally less than about 100° C., such as less than about 95° C., and generally greater than about 40° C. In one embodiment, the wetting agent can be acetone. Alternatively, the wetting agent can be dimethyl carbonate. Other wetting agents that may be used include cyclohexinone, methyl ethyl ketone, methyl acetate, tert-butyl acetate, propylene carbonate, parachlorobenzotrifluoride, and ethyl acetate. During the process, a single wetting agent can be added to the polymer mixture or a blend of wetting agents can be used. The wetting agent is generally added to the polymer mixture in an amount from about 0.05% by weight to about 10% by weight, such as from about 0.1% by weight to about 8% by weight, such as from about 0.1% by weight to about 6% by weight, based upon the weight of the cellulose ester particles (excluding the amount of plasticizer present).

Due to the presence of the wetting agent, homogeneous cellulose ester polymer and plasticizer blends can be formed without having to dry the cellulose ester particles or grind the cellulose ester particles. For example, the cellulose ester particles that are combined with the plasticizer and wetting agent can have a moisture content of greater than about 2% by weight, such as greater than about 2.5% by weight, such as greater than about 2.8% by weight, and generally less than about 5% by weight, such as less than about 4% by weight, such as less than about 3.5% by weight. The cellulose ester particles can be in the form of flakes and can have a particle size such that greater than 50% of the particles on a weight basis have a size greater than 850 microns when tested according to a sieve test. Alternatively, the cellulose ester polymer is in the form of granulated particles have an average particle size of from about 1 mm to about 8 mm.

In one embodiment, the cellulose ester particles, the plasticizer, and the wetting agent are all fed directly to an extruder. The three components can be blended within the extruder for producing the cellulose ester product. In one embodiment, for instance, each of the three components can be fed at different locations along the length of the extruder.

The plasticizer combined with the cellulose ester particles can be, in one aspect, at ambient temperature. Alternatively, the plasticizer can be preheated prior to contact with the cellulose ester particles. The plasticizer can be preheated to a temperature of greater than about 30° C., such as greater than about 35° C.

The plasticizer combined with the cellulose ester polymer can also comprise any suitable plasticizer. Examples of plasticizers include tris(clorisopropyl) phosphate, tris(2-chloro-1-methylethyl) phosphate, glycerin, monoacetin, triethyl citrate, acetyl triethyl citrate, a phthalate, an adipate, polyethylene glycol, triacetin, diacetin, trimethyl phosphate, triethyl phosphate, tributyl phosphate, triphenyl phosphate, tributyl-o-acetyl citrate, dibutyl tartrate, ethyl o-benzoylbenzoate, n-ethyltoluenesulfonamide, o-cresyl p-toluenesulfonate, aromatic diol, a substituted aromatic diol, an aromatic ether, tripropionin, tribenzoin, glycerin esters, glycerol tribenzoate, glycerol acetate benzoate, polyethylene glycol, a polyethylene glycol ester, a polyethylene glycol diester, di-2-ethylhexyl polyethylene glycol ester, a glycerol ester, diethylene glycol, polypropylene glycol, a polyglycoldiglycidyl ether, dimethyl sulfoxide, N-methyl pyrollidinone, propylene carbonate, a C1-C20 dicarboxylic acid ester, di-butyl maleate, di-octyl maleate, resorcinol monoacetate, catechol, catechol esters, phenols, epoxidized soy bean oil, castor oil, linseed oil, epoxidized linseed oil, difunctional glycidyl ether based on polyethylene glycol, an alkyl lactone, a phospholipid, 2-phenoxyethanol, acetylsalicylic acid, acetaminophen, naproxen, imidazole, triethanol amine, benzoic acid, benzyl benzoate, salicylic acid, 4-hydroxybenzoic acid, propyl-4-hydroxybenzoate, methyl-4-hydroxybenzoate, ethyl-4-hydroxybenzoate, benzyl-4-hydroxybenzoate, glyceryl tribenzoate, neopentyl dibenzoate, triethylene glycol dibenzoate, trimethylolethane tribenzoate, butylated hydroxytoluene, butylated hydroxyanisol, sorbitol, xylitol, ethylene diamine, piperidine, piperazine, hexamethylene diamine, triazine, triazole, pyrrole, and mixtures thereof.

The plasticized cellulose ester product of the present disclosure can generally contain cellulose ester in an amount from about 15% to about 95% by weight, such as in an amount from about 60% to about 95% by weight. One or more plasticizers can be present in the product in an amount from about 3% to about 40% by weight, such as in an amount from about 3% to about 35% by weight. In addition to the cellulose ester and plasticizer, the plasticized cellulose ester product can also contain various other additives such as an antioxidant, a stabilizer, an organic acid, an oil, filler particles, glass fibers, a pigment, a bio-based polymer other than the cellulose ester, a biodegradable enhancer, a foaming agent, or mixtures thereof. In one aspect, the cellulose ester product contains a mineral filler. The mineral filler can comprise talc, calcium carbonate, a metal oxide, mica, or mixtures thereof. Another additive or component that can be contained in the final product is a coloring agent. The coloring agent can comprise an organic dye, an inorganic dye, a pigment, or mixtures thereof.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a cross-sectional view of one embodiment of a process in accordance with the present disclosure.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only, and is not intended as limiting the broader aspects of the present disclosure.

In general, the present disclosure is directed to a process for producing a cellulose ester and plasticizer product. The process of the present disclosure ensures excellent mixing between the plasticizer and cellulose ester. In one aspect, a pre-compounded product is produced that contains a substantially homogeneous blend of the cellulose ester and plasticizer. The plasticized cellulose ester product can then be used to mold all different types of products. The plasticized cellulose ester product may have improved melt processing properties and may produce molded products with better and more uniform properties and characteristics.

The process of the present disclosure generally includes combining cellulose ester particles with a plasticizer and a wetting agent and melt processing the mixture to form a cellulose ester polymer and plasticizer product. The wetting agent has been found to dramatically improve the ability of the cellulose ester particles and the plasticizer to blend together and form a homogeneous composition. In fact, the presence of the wetting agent makes it unnecessary to pre-blend the plasticizer and cellulose ester particles prior to melt processing. The wetting agent also makes it unnecessary to first grind the cellulose ester particles down to a smaller size and/or remove moisture from the cellulose ester particles prior to combining with the plasticizer.

Not only does the wetting agent significantly improve blending of the cellulose ester particles and the plasticizer, but also, in one embodiment, can be removed during melt processing so that the wetting agent does not remain in the final product. For example, wetting agents can be selected that volatilize during melt processing. Consequently, the cellulose ester and plasticizer product produced according to the present disclosure can, in one aspect, contain the wetting agent in an amount less than about 1° A by weight, such as in an amount less than about 0.1° A by weight, such as in an amount less than about 0.01% by weight, and, in one embodiment, can be completely free of the wetting agent. Consequently, the wetting agent not only dramatically improves the efficiency of combining the cellulose ester polymer and the plasticizer but also does so without changing the final composition that is desired.

Use of the wetting agent can also improve the final product characteristics. For example, in the past, direct liquid feeding of plasticizer and cellulose ester particles generally resulted in insufficient mixing and the formation of gels in the exudate and product. The formation of gels during processing can not only affect in a negative way the physical properties of any resulting product but also can negatively affect the appearance of any product formed. Use of the wetting agent, however, can significantly reduce or eliminate the formation of gels during processing and can produce a product with smoother surface characteristics, that is clearer and has better optical and visual appearance, and has more uniform properties.

In general, any suitable cellulose ester polymer can be used in the process of the present disclosure. In one aspect, the cellulose ester polymer can be a cellulose acetate, such as cellulose diacetate, cellulose triacetate, cellulose acetate propionate, cellulose acetate butyrate, and the like. In addition, various other modified cellulose esters may be used.

Cellulose acetate may be formed by esterifying cellulose after activating the cellulose with acetic acid. The cellulose may be obtained from numerous types of cellulosic material, including but not limited to plant derived biomass, corn stover, sugar cane stalk, bagasse and cane residues, rice and wheat straw, agricultural grasses, hardwood, hardwood pulp, softwood, softwood pulp, cotton linters, switchgrass, bagasse, herbs, recycled paper, waste paper, wood chips, pulp and paper wastes, waste wood, thinned wood, willow, poplar, perennial grasses (e.g., grasses of the Miscanthus family), bacterial cellulose, seed hulls (e.g., soy beans), cornstalk, chaff, and other forms of wood, bamboo, soyhull, bast fibers, such as kenaf, hemp, jute and flax, agricultural residual products, agricultural wastes, excretions of livestock, microbial, algal cellulose, seaweed and all other materials proximately or ultimately derived from plants. Such cellulosic raw materials are preferably processed in pellet, chip, clip, sheet, attritioned fiber, powder form, or other form rendering them suitable for further purification.

Cellulose esters suitable for use in the process of the present disclosure may, in some embodiments, have ester substituents that include, but are not limited to, C₁-C₂₀ aliphatic esters (e.g., acetate, propionate, or butyrate), functional C₁-C₂₀ aliphatic esters (e.g., succinate, glutarate, maleate) aromatic esters (e.g., benzoate or phthalate), substituted aromatic esters, and the like, any derivative thereof, and any combination thereof.

The cellulose acetate used in the process may be cellulose diacetate or cellulose triacetate. In one embodiment, the cellulose acetate comprises primarily cellulose diacetate. For example, the cellulose acetate can contain less than 1% by weight cellulose triacetate, such as less than about 0.5% by weight cellulose triacetate. Cellulose diacetate can make up greater than 90% by weight of the cellulose acetate, such as greater than about 95% by weight, such as greater than about 98% by weight, such as greater than about 99% by weight of the cellulose acetate.

In general, the cellulose acetate can have a molecular weight of greater than about 10,000, such as greater than about 20,000, such as greater than about 30,000, such as greater than about 40,000, such as greater than about 50,000. The molecular weight of the cellulose acetate is generally less than about 300,000, such as less than about 250,000, such as less than about 200,000, such as less than about 150,000, such as less than about 100,000, such as less than about 90,000, such as less than about 70,000, such as less than about 50,000. The molecular weights identified above refer to the number average molecular weight. Molecular weight can be determined using gel permeation chromatography using a polystyrene equivalent or standard.

In general, the cellulose ester polymer can have a degree of acetyl substitution of from about 1.8 to about 3.4, such as from about 2.1 to about 2.8, including all increments of 0.1 therebetween. The degree of substitution of cellulose ester can be measured using ASTM Test 871-96 (2010). In one aspect, the degree of substitution is greater than about 2.2, such as greater than about 2.3, and generally less than about 2.9, such as less than about 2.8, such as less than about 2.6, such as less than about 2.4

The cellulose ester polymer or cellulose acetate can have an intrinsic viscosity of generally greater than about 0.5 dL/g, such as greater than about 0.8 dL/g, such as greater than about 1 dL/g, such as greater than about 1.2 dL/g, such as greater than about 1.4 dL/g, such as greater than about 1.6 dL/g. The intrinsic viscosity is generally less than about 2 dL/g, such as less than about 1.8 dL/g, such as less than about 1.7 dL/g, such as less than about 1.65 dL/g. Intrinsic viscosity may be measured by forming a solution of 0.20 g/dL cellulose ester in 98/2 wt/wt acetone/water and measuring the flow times of the solution and the solvent at 30° C. in a #25 Cannon-Ubbelohde viscometer. Then, the modified Baker-Philippoff equation may be used to determine intrinsic viscosity (“IV”), which for this solvent system is Equation 1.

$$IV = ( \frac{k}{c} ) ( antilog ( ( log {n}_{ret} ) / k ) - 1 ) \qquad Equation 1$$

$$where {n}_{rel} = ( \frac{{t}_{1}}{{t}_{2}} ) ,$$

t₁=the average flow time of solution (having cellulose ester) in seconds, t₂=the average flow times of solvent in seconds, k=solvent constant (10 for 98/2 wt/wt acetone/water), and c=concentration (0.200 g/d L).

The cellulose ester polymer that is combined with the plasticizer and wetting agent in accordance with the process of the present disclosure is in the form of particles. For instance, the cellulose ester particles can have a round shape, an irregular shape, or can be in the shape of a flake.

As described above, one of the advantages to incorporating a wetting agent into the process of the present disclosure is the ability to process cellulose ester particles in their “raw” state without having to grind the particles to a smaller size or subject the particles to a drying process. Consequently, in one embodiment, the cellulose ester particles fed into the process are virgin flakes as produced by the cellulose ester polymer process. For example, in one embodiment, greater than about 50% by weight, such as greater than about 60% by weight, such as greater than about 70% by weight of the cellulose ester particles have a particle size of greater than about 850 microns. Particle size can be determined according to a sieve test using standard size sieve screens. For example, particle size can be determined by placing a 200 gram sample of the particles in a RO-TAP AS200 automatic shaker available from Retsch containing different sized sieve screens. The amplitude setting is 1.25 mm/g and the shake time is 15 minutes.

In one aspect, greater than about 20% by weight, such as greater than about 25% by weight, such as greater than about 30% by weight, such as greater than about 40% by weight, such as greater than about 45% by weight of the cellulose ester particles has a particle size of greater than about 2,000 microns. In general, less than about 70% by weight, such as less than about 90% by weight of the particles have a particle size of greater than 2,000 microns. In one aspect, less than 50% by weight, such as less than about 40% by weight, such as less than about 30% by weight, such as less than about 20% by weight have a particle size of less than 500 microns. Some of the particles contained within the cellulose ester can have a particle size of up to about 50,000 microns, such as up to about 30,000 microns, such as up to about 25,000 microns.

When in the shape of a flake, the cellulose ester particles can have an aspect ratio of greater than about 1:4 (thickness to largest dimension), such as greater than about 1:8, such as greater than about 1:12, such as greater than about 1:20, such as greater than about 1:30, such as greater than about 1:40, and generally less than about 1:100, such as less than about 1:50.

Although the cellulose ester particles fed to the process of the present disclosure can have relatively large sizes, in one aspect, the flake or particles can be ground. The particle size of the cellulose ester, for instance, can vary depending upon the particular application and the desired result. In one aspect, the average particle size of the cellulose ester particles can be greater than about 10 microns, such as greater than about 50 microns, such as greater than about 70 microns, such as greater than about 100 microns, such as greater than about 120 microns, such as greater than about 140 microns. The average particle size of the ground cellulose ester particles can be generally less than about 500 microns, such as less than about 400 microns, such as less than about 300 microns, such as less than about 200 microns, such as less than about 160 microns.

In addition to not having to reduce the particle size of the cellulose ester polymer, the use of the wetting agent in accordance with the present disclosure also makes it unnecessary to dry the cellulose ester particles prior to being fed into the process. Although unknown, it is believed that the wetting agent neutralizes the presence of moisture and prevents moisture from interfering with the plasticizer and cellulose ester polymer mixture. In this regard, the cellulose ester particles fed into the process of the present disclosure can have a moisture content of greater than about 2%, such as greater than about 2.2%, such as greater than about 2.4%, such as greater than about 2.6%. The moisture content can be less than about 7%, such as less than about 5%, such as less than about 4%, such as less than about 2.8%, such as less than about 2.7% by weight.

If desired, however, the cellulose ester particles can be preheated or dried prior to being fed into the process and contacted with the plasticizer and wetting agent. For example, the cellulose ester particles can be preheated or dried such that the particles contain moisture or water in an amount less than about 2% by weight, such as in an amount less than about 1.5% by weight, such as in an amount less than about 1% by weight, such as in an amount less than about 0.7% by weight. The cellulose ester particles generally contain water in an amount greater than about 0.5% by weight.

The cellulose ester particles can be preheated if desired to a temperature of greater than about 40° C., such as greater than about 50° C., such as greater than about 55° C., such as greater than about 60° C., such as greater than about 70° C., such as greater than about 80° C., and generally less than about 90° C., such as less than about 80° C.

In accordance with the present disclosure, the cellulose ester particles are contacted with one or more plasticizers and one or more wetting agents prior to or during melt processing of the polymer. The wetting agent dramatically improves the blending characteristics of the cellulose ester particles and the plasticizer. The wetting agent can be, for instance, a liquid having a boiling point of less than water, such as less than about 100° C. For instance, the boiling point of the wetting agent can be less than about 95° C. The boiling point is generally greater than about 30° C., such as greater than about 40° C., such as greater than about 50° C. The wetting agent can have a vapor pressure of less than about 400 mmHg, such as less than about 300 mmHg, such as less than about 270 mmHg, and generally has a vapor pressure of greater than about 30 mmHg, such as greater than about 40 mmHg when measured at 25° C. The vapor pressure, for instance, in one embodiment, can be from about 210 mmHg to about 270 mmHg. In an alternative embodiment, the vapor pressure can be from about 40 mmHg to about 100 mmHg at 25° C. In one embodiment, the wetting agent is not a volatile organic compound as classified by the United States Environmental Protection Agency.

In one aspect, the wetting agent can be an organic liquid. Examples of wetting agents that can be used include acetone, dimethyl carbonate, cyclohexinone, methyl ethyl ketone, methyl acetate, tert-butyl acetate, parachlorobenzotrifluoride, propylene carbonate, ethyl acetate, and mixtures thereof. In one particular embodiment, acetone is used alone or in combination with the above other wetting agents. In another embodiment, the wetting agent can be dimethyl carbonate used alone or in combination with one of the other wetting agents.

The amount of wetting agent added during the process can be based upon the amount of cellulose acetate polymer present. For example, one or more wetting agents can be present during the process in an amount generally greater than about 0.05% by weight, such as greater than about 0.1% by weight, such as greater than about 0.5% by weight, such as greater than about 1% by weight, such as greater than about 2% by weight, such as greater than about 3% by weight, such as greater than about 4% by weight, such as greater than about 5% by weight, such as greater than about 6% by weight based upon the weight of the cellulose ester particles. The amount of wetting agent present during the process is generally less than about 25% by weight, such as less than about 20% by weight, such as less than about 15% by weight, such as less than about 10% by weight, such as less than about 6% by weight, such as less than about 4% by weight, such as less than about 2% by weight, such as less than about 1.5% by weight, such as less than about 1% by weight, such as less than about 0.5% by weight, based on the weight of the cellulose ester particles present. The amount of wetting agent present can depend upon various factors including the amount of plasticizer, the chemical makeup of the cellulose ester polymer, and the properties of the wetting agent.

The wetting agent selected is combined with the cellulose ester particles and one or more plasticizers. The plasticizer can contact the cellulose ester particles while the plasticizer is at ambient temperature. Alternatively, the plasticizer can be preheated and then contacted with the cellulose ester particles. For example, the plasticizer can be preheated in order to adjust or decrease the viscosity. When the plasticizer is preheated, the plasticizer can be heated to a temperature of greater than about 30° C., such as greater than about 35° C., such as greater than about 40° C., such as greater than about 50° C., such as greater than about 55° C., such as greater than about 60° C., and generally less than about 100° C., such as less than about 90° C., such as less than about 80° C.

In one embodiment, the cellulose ester particles, the plasticizer, and the wetting agent are all fed directly to an extruder. The three components can be blended within the extruder for producing the cellulose ester product. In one embodiment, for instance, each of the three components can be fed at different locations along the length of the extruder. In one aspect, the wetting agent and the plasticizer can be fed to the extruder at more than one location.

In one embodiment, the extruder includes a single plasticizer feed. Alternatively, one or more plasticizers can be fed at different locations along the extruder. For example, in one embodiment, the cellulose ester particles can be premixed with a plasticizer in addition to being combined downstream with a plasticizer from a plasticizer feed. In another embodiment, the extruder can include additional plasticizer feeds that are positioned downstream from the wetting agent feed.

In an alternative embodiment, the plasticizer alone or in combination with a wetting agent can be combined simultaneously with the cellulose acetate flake in the extruder. Further amounts of the plasticizer and the wetting agent can then be combined with the cellulose acetate further downstream in the extruder. Ratios of the plasticizer to wetting agent feed and injection points can be optimized.

In general, any suitable plasticizer or blend of plasticizers may be combined with the cellulose ester particles and wetting agent.

Plasticizers particularly well suited for use in the process include triacetin, monoacetin, diacetin, and mixtures thereof. Other suitable plasticizers include tris(clorisopropyl) phosphate, tris(2-chloro-1-methylethyl) phosphate, triethyl citrate, acetyl triethyl citrate, glycerin, or mixtures thereof.

Other examples of plasticizers include, but are not limited to, trimethyl phosphate, triethyl phosphate, tributyl phosphate, triphenyl phosphate, acetyl tributyl citrate, tributyl-o-acetyl citrate, dibutyl tartrate, ethyl o-benzoylbenzoate, n-ethyltoluenesulfonamide, o-cresyl p-toluenesulfonate, aromatic diol, substituted aromatic diols, aromatic ethers, tripropionin, tribenzoin, glycerin, glycerin esters, glycerol tribenzoate, glycerol acetate benzoate, polyethylene glycol, polyethylene glycol esters, polyethylene glycol diesters, di-2-ethylhexyl polyethylene glycol ester, glycerol esters, diethylene glycol, polypropylene glycol, polyglycoldiglycidyl ethers, dimethyl sulfoxide, N-methyl pyrollidinone, propylene carbonate, C₁-C₂₀ dicarboxylic acid esters, dimethyl adipate (and other dialkyl esters), di-butyl maleate, di-octyl maleate, resorcinol monoacetate, catechol, catechol esters, phenols, epoxidized soy bean oil, castor oil, linseed oil, epoxidized linseed oil, other vegetable oils, other seed oils, difunctional glycidyl ether based on polyethylene glycol, alkyl lactones (e.g., .gamma.-valerolactone), alkylphosphate esters, aryl phosphate esters, phospholipids, aromas (including some described herein, e.g., eugenol, cinnamyl alcohol, camphor, methoxy hydroxy acetophenone (acetovanillone), vanillin, and ethylvanillin), 2-phenoxyethanol, glycol ethers, glycol esters, glycol ester ethers, polyglycol ethers, polyglycol esters, ethylene glycol ethers, propylene glycol ethers, ethylene glycol esters (e.g., ethylene glycol diacetate), propylene glycol esters, polypropylene glycol esters, acetylsalicylic acid, acetaminophen, naproxen, imidazole, triethanol amine, benzoic acid, benzyl benzoate, salicylic acid, 4-hydroxybenzoic acid, propyl-4-hydroxybenzoate, methyl-4-hydroxybenzoate, ethyl-4-hydroxybenzoate, benzyl-4-hydroxybenzoate, glyceryl tribenzoate, neopentyl dibenzoate, triethylene glycol dibenzoate, trimethylolethane tribenzoate, butylated hydroxytoluene, butylated hydroxyanisol, sorbitol, xylitol, ethylene diamine, piperidine, piperazine, hexamethylene diamine, triazine, triazole, pyrrole, and the like, any derivative thereof, and any combination thereof.

In one aspect, a carbonate ester may serve as a plasticizer. Exemplary carbonate esters may include, but are not limited to, propylene carbonate, butylene carbonate, diphenyl carbonate, phenyl methyl carbonate, dicresyl carbonate, glycerin carbonate, dimethyl carbonate, diethyl carbonate, ethylene carbonate, propylene carbonate, isopropylphenyl 2-ethylhexyl carbonate, phenyl 2-ethylhexyl carbonate, isopropylphenyl isodecyl carbonate, isopropylphenyl tridecyl carbonate, phenyl tridecyl carbonate, and the like, and any combination thereof.

In still another aspect, the plasticizer can be a polyol benzoate. Exemplary polyol benzoates may include, but are not limited to, glyceryl tribenzoate, propylene glycol dibenzoate, diethylene glycol dibenzoate, dipropylene glycol dibenzoate, triethylene glycol dibenzoate, sucrose benzoate, polyethylene glycol dibenzoate, neopentylglycol dibenzoate, trimethylolpropane tribenzoate, trimethylolethane tribenzoate, pentaerythritol tetrabenzoate, sucrose benzoate (with a degree of substitution of 1-8), and combinations thereof. In some instances, tribenzoates like glyceryl tribenzoate may be preferred. In some instances, polyol benzoates may be solids at 25° C. and a water solubility of less than 0.05 g/100 mL at 25° C.

The plasticizer can also be bio-based. Bio-based plasticizers particularly well suited for use in the composition of the present disclosure include an alkyl ketal ester, a non-petroleum hydrocarbon ester, a bio-based polymer or oligomer, such as polycaprolactone, having a number average molecular weight of 1000 or less, or mixtures thereof.

In one aspect, the bio-based plasticizer is an alkyl ketal ester having a chemical structure corresponding to Structure I as provided below:

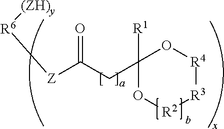

wherein a is from 0 to 12; b is 0 or 1; each R¹ is independently hydrogen, a hydrocarbyl group, or a substituted hydrocarbyl group; each R², R³, and R⁴ are independently methylene, alkylmethylene, or dialkylmethylene, x is at least 1, y is 0 or a positive number and x+y is at least 2; R⁶ is a hydrocarbyl group or a substituted hydrocarbyl group and each Z is independently —O—, —NH— or —NR— where R is a hydrocarbyl group or a substituted hydrocarbyl group.

The plasticizer identified above corresponds to a reaction product of a polyol, aminoalcohol or polyamine and certain 1,2- and/or 1,3-alkanediol ketal of an oxocarboxylate esters. 1,2- and 1,3-alkanediols ketals of oxocarboxylate esters are referred to herein as “alkyl ketal esters”. Up to one mole of alkyl ketal ester can be reacted per equivalent of hydroxyl groups or amino groups provided by the polyol, aminoalcohol or polyamine. The polyol, aminoalcohol or polyamine is most preferably difunctional, but polyols, aminoalcohols and polyamines having more than two hydroxyl and/or amino groups can be used.

The values of x and y in structure I will depend on the number of hydroxyl groups or amino groups on the polyol, aminoalcohol or polyamine, the number of moles of the alkyl ketal ester per mole of the polyol, aminoalcohol or polyamine, and the extent to which the reaction is taken towards completion. Higher amounts of the alkyl ketal ester favor lower values for y and higher values of x.

In structure I, y is specifically from 0 to 2 and x is specifically at least 2. All a in structure I are specifically 2 to 12, more specifically, 2 to 10, more specifically, 2 to 8, more specifically, 2 to 6, more specifically, 2 to 4, and more specifically, 2. All R¹ are specifically an alkyl group, specifically methyl. In some embodiments of structure I, all Z are —O—, y is 0 and x is 2; these products correspond to a reaction of two moles of an alkyl ketal ester and one mole of a diol. In some other embodiments, all Z are —O—, y is 1 and x is 1; these products correspond to the reaction of one mole of the alkyl ketal ester and one mole of a diol.

In one embodiment, all b are 0. In another embodiment, all b are 1.

Some specific compounds according to structure I include those having the structure:

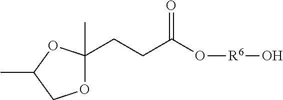

or the structure

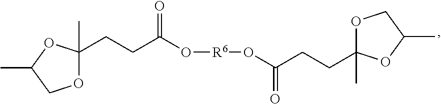

or the structure

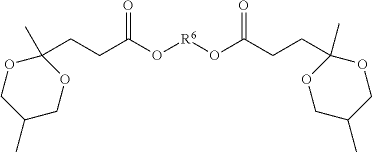

particularly in which R⁶ is —(CH₂)—ₘ wherein m is from 2 to 18, especially 2, 3, 4 or 6. In one specific embodiment, R⁶ corresponds to the residue, after removal of hydroxyl groups, of 1,4-butane diol resulting in the structure (Ia)

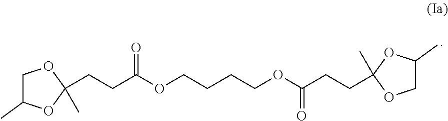

In another specific embodiment, R⁶ corresponds to the residue, after removal of hydroxyl groups, of diethylene glycol resulting in structure (Ib)

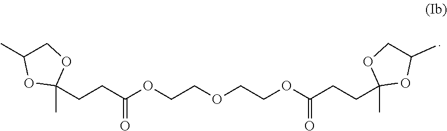

In another specific embodiment, R⁶ corresponds to the residue, after removal of hydroxyl groups, of 2-methyl. 1-3 propane diol resulting in structure (Ic)

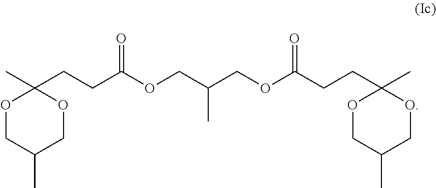 [SMILES: CC(COC(=O)CCC1(C)OCC(C)CO1)COC(=O)CCC1(C)OCC(C)CO1]

Compounds according to structure I can be prepared in a transesterification or ester-am inolysis reaction between the corresponding polyol, aminoalcohol or polyamine and the corresponding alkyl ketal ester. Alternatively, compounds according to structure I can be prepared by reacting an oxocarboxylic acid with the polyol, aminoalcohol or polyamine to form an ester or amide, and then ketalizing the resulting product with a 1,2- or 1,3-alkane diol such as ethylene glycol, 1,2-propanediol, 1,3-propanediol, 2-methyl, 1-3 propane diol, 1,2-butanediol, 1,3-butanediol, 1,2-pentanediol, 1,3-pentanediol, 1,2-hexanediol, 1,3-hexanediol, and the like.

Another bio-based plasticizer that may be incorporated into the polymer composition of the present disclosure is a non-petroleum hydrocarbon ester. For example, one example of a non-petroleum hydrocarbon ester is sold under the tradename HALLGREEN by the Hall Star Company of Chicago, Illinois. Non-petroleum hydrocarbon ester plasticizers, for instance, can contain greater than about 50% by weight, such as greater than about 70% by weight, such as greater than about 99% by weight of bio-based content. The esters, for instance, can be derived primarily from agricultural, forestry, or marine materials and thus are biodegradable. In one aspect, the non-petroleum hydrocarbon ester plasticizer has a specific gravity at 25° C. of about 1.16 or greater, such as about 1.165 or greater, such as about 1.17 or greater, such as about 1.74 or greater, and generally about 1.19 or less, such as about 1.185 or less, such as about 1.18 or less, such as about 1.78 or less. The non-petroleum hydrocarbon ester plasticizer can have an acid value of from about 0.5 mgKOH/g to about 0.6 mgKOH/g, such as from about 0.53 mgKOH/g to about 0.57 mgKOH/g.

In one aspect, the plasticizer is phthalate-free. In fact, the polymer composition and product can be formulated to be phthalate-free. For instance, phthalates can be present in the polymer composition and/or product in an amount of about 0.5% or less, such as in an amount of about 0.1° A or less.

The amount of cellulose ester and the amount of plasticizer that are combined together can vary depending upon the particular application.

The cellulose acetate is generally present in the polymer composition or product in an amount greater than about 15% by weight, such as in an amount greater than about 25% by weight, such as in an amount greater than about 35% by weight, such as in an amount greater than about 45% by weight, such as in an amount greater than about 55% by weight. The cellulose acetate is generally present in the polymer composition in an amount less than about 85% by weight, such as in an amount less than about 80% by weight, such as in an amount less than about 75% by weight, such as in an amount less than about 70% by weight, such as in an amount less than about 65% by weight.

In general, one or more plasticizers can be present in the polymer composition or product in an amount from about 8% to about 40% by weight, such as in an amount from about 12% to about 35% by weight. In one aspect, one or more plasticizers can be present in the polymer composition in an amount of about 19% or less, such as in an amount of about 17% or less, such as in an amount of about 15% or less, such as in an amount of about 13% or less, such as in an amount of about 10% or less. One or more plasticizers are generally present in an amount from about 5% or greater, such as in an amount of about 10% or greater.

The cellulose acetate can be present in relation to the plasticizer such that the weight ratio between the cellulose acetate and the one or more plasticizers is from about 60:40 to about 85:15, such as from about 70:30 to about 80:20. In one embodiment, the cellulose acetate to plasticizer weight ratio is about 75:25.

In accordance with the present disclosure, the cellulose ester particles, the plasticizer, and the wetting agent are melt processed together to form a cellulose ester product. For example, in one embodiment, the cellulose ester, plasticizer and wetting agent mixture can be fed through an extruder and formed into pellets. The pellets are then well suited to being fed into a downstream molding process for producing molded articles. The size of the pellets is generally not critical. The pellets can have, for instance, any size suitable for the downstream molding process. Just as an example, the pellets, in one embodiment, can have an average particle size of greater than about 0.5 mm, such as greater than about 1 mm, such as greater than about 3 mm, such as greater than about 5 mm, and generally less than about 10 mm, such as less than about 8 mm, such as less than about 6 mm.

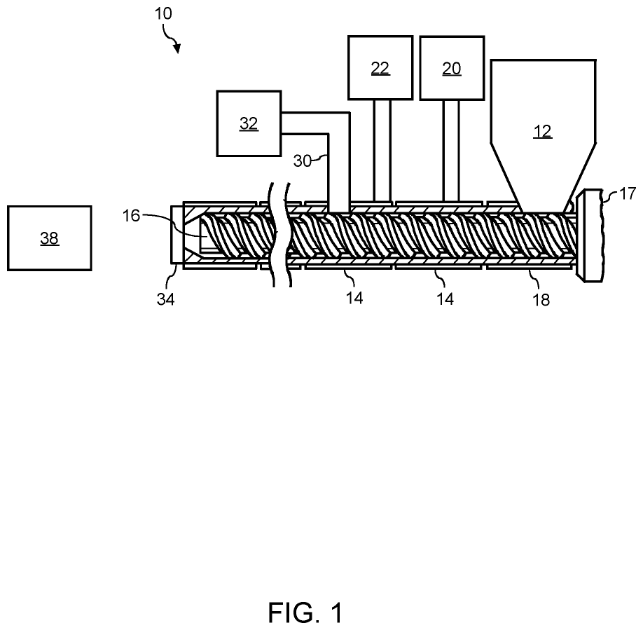

Referring to FIG. 1, for exemplary purposes only, one embodiment of a process that may be used to produce cellulose ester products in accordance with the present disclosure is shown. More particularly, FIG. 1 illustrates an extruder 10 that can be used to combine the cellulose ester particles with the plasticizer and wetting agent in accordance with the present disclosure. As illustrated, the extruder 10 is placed in association with a hopper 12 for feeding the cellulose ester particles into the extruder. The cellulose ester particles can be gravity fed into the extruder or can be subjected to external forces for metering the cellulose ester particles into the extruder.

The extruder 10 can comprise a series of barrels 14 with at least one extrusion screw 16 disposed axially therein. The extrusion screw 16 may be driven by a screw drive motor 17.

In the embodiment illustrated in FIG. 1, the extruder 10 includes a single extrusion screw 16. It should be understood, however, that the extruder 10 can include multiple extrusion screws. For example, in one embodiment, the extruder 10 is a double screw extruder.

As shown in FIG. 1, the extruder 10 includes a plurality of barrels 14 including a feed barrel 18. The extruder 10 can include anywhere from about 4 to about 24 barrels 14. For example, the extruder 10 can include greater than 6 barrels, such as greater than 8 barrels, such as greater than 10 barrels, and generally less than about 20 barrels, such as less than about 18 barrels. As shown, the barrels 14 are arranged serially. Each barrel 14 can provide a controlled environment during melt processing of the cellulose ester polymer. For example, the temperature within each barrel 14 can be controlled.

As described above, the cellulose acetate particles are fed to the extruder 10 using the hopper 12. In one embodiment, one or more plasticizers can be fed to the extruder 10 downstream of the hopper 12. For example, as shown in FIG. 1, the extruder 10 includes a plasticizer feed 20 that feeds a plasticizer to the extruder for combining with the cellulose ester particles.

In the embodiment illustrated in FIG. 1, the extruder 10 further includes a wetting agent feed 22 that is positioned downstream from both the hopper 12 and the plasticizer feed 20. The wetting agent feed 22 is for feeding a wetting agent into the extruder 10 for mixing with the plasticizer and cellulose ester particles. The wetting agent dramatically improves the ability of the plasticizer and cellulose ester particles to blend and form a homogeneous mix.

During melt processing, the wetting agent can volatilize and thus should be removed from the extruder 10 during the process in order to prevent an increase in pressure within the system. In this regard, the extruder 10 can include one or more vents 30 that are optionally coupled to a vacuum 32. The one or more vents 30 can allow for any volatile matter, including evaporated water, to be released from the extruder 10.

A die plate 34 can be located at the outlet of the extruder 10 to create a desired size and shape of the cellulose ester product. For example, in one embodiment, the die plate 34 can be designed to produce strands comprised of the cellulose ester product. The strands can be cut into pellets and/or can be fed to a granulator 38. In this manner, the final product can be in the form of pellets or granules that can then be fed to other processes for forming various products.

In the embodiment illustrated in FIG. 1, the extruder 10 includes a single plasticizer feed 20. It should be understood, however, that one or more plasticizers can be fed at different locations along the extruder. For example, in one embodiment, the cellulose ester particles can be premixed with a plasticizer in addition to being combined with a plasticizer from the plasticizer feed 20. In another embodiment, the extruder 10 can include additional plasticizer feeds that are positioned downstream from the wetting agent feed 22.

In an alternative embodiment, the plasticizer alone or in combination with a wetting agent can be combined simultaneously with the cellulose acetate flake in the extruder 10. Further amounts of the plasticizer and the wetting agent can then be combined with the cellulose acetate further downstream in the extruder 10. Ratios of the plasticizer to wetting agent feed can be optimized.

The plasticized cellulose ester product made in accordance with the present disclosure offers numerous advantages and benefits. For instance, the product includes an intimate mixture between the plasticizer and cellulose ester without creating a gel-like or liquid suspension product. Instead, the plasticized cellulose ester product is easy to handle and has good flow properties for being fed to various different molding processes, such as injection molding, blow molding, and the like. In addition, because the plasticizer is well blended with the cellulose ester, products are produced with uniform properties. In addition, the melt processing characteristics of the product are uniform making it easier to form products through a molding process.

In addition to the cellulose ester polymer and one or more plasticizers, the plasticized cellulose ester product of the present disclosure can also contain various other additives and ingredients. These additives and ingredients can be incorporated into the product during formation of the pellets. Alternatively, these additives and ingredients can be incorporated into the downstream molding process for incorporation into the final product being formed.

For instance, the polymer composition may contain antioxidants, pigments, lubricants, softening agents, acid scavengers, antibacterial agents, antifungal agents, preservatives, flame retardants, and combinations thereof. Each of the above additives can generally be present in the polymer composition in an amount of about 5% or less, such as in an amount of about 2% or less, and generally in an amount of about 0.1° A or greater, such as in an amount of about 0.3% or greater.

Flame retardants suitable for use in conjunction with a cellulose ester plastic described herein may, in some embodiments, include, but are not limited to, silica, metal oxides, phosphates, catechol phosphates, resorcinol phosphates, borates, inorganic hydrates, aromatic polyhalides, and the like, and any combination thereof.

Antifungal and/or antibacterial agents suitable for use in conjunction with a cellulose ester plastic described herein may, in some embodiments, include, but are not limited to, polyene antifungals (e.g., natamycin, rimocidin, filipin, nystatin, amphotericin B, candicin, and hamycin), imidazole antifungals such as miconazole (available as MICATIN® from WellSpring Pharmaceutical Corporation), ketoconazole (commercially available as NIZORAL® from McNeil consumer Healthcare), clotrimazole (commercially available as LOTRAMIN® and LOTRAMIN AF® available from Merck and CANESTEN® available from Bayer), econazole, omoconazole, bifonazole, butoconazole, fenticonazole, isoconazole, oxiconazole, sertaconazole (commercially available as ERTACZO® from OrthoDematologics), sulconazole, and tioconazole; triazole antifungals such as fluconazole, itraconazole, isavuconazole, ravuconazole, posaconazole, voriconazole, terconazole, and albaconazole), thiazole antifungals (e.g., abafungin), allylamine antifungals (e.g., terbinafine (commercially available as LAMISIL® from Novartis Consumer Health, Inc.), naftifine (commercially available as NAFTIN® available from Merz Pharmaceuticals), and butenafine (commercially available as LOTRAMIN ULTRA® from Merck), echinocandin antifungals (e.g., anidulafungin, caspofungin, and micafungin), polygodial, benzoic acid, ciclopirox, tolnaftate (e.g., commercially available as TINACTIN® from MDS Consumer Care, Inc.), undecylenic acid, flucytosine, 5-fluorocytosine, griseofulvin, haloprogin, caprylic acid, and any combination thereof.

Preservatives suitable for use in conjunction with a cellulose ester plastic described herein may, in some embodiments, include, but are not limited to, benzoates, parabens (e.g., the propyl-4-hydroxybenzoate series), and the like, and any combination thereof.

Pigments and dyes suitable for use in conjunction with a cellulose ester plastic described herein may, in some embodiments, include, but are not limited to, plant dyes, vegetable dyes, titanium dioxide, silicon dioxide, tartrazine, E102, phthalocyanine blue, phthalocyanine green, quinacridones, perylene tetracarboxylic acid di-imides, dioxazines, perinones disazo pigments, anthraquinone pigments, carbon black, metal powders, iron oxide, ultramarine, calcium carbonate, kaolin clay, aluminum hydroxide, barium sulfate, zinc oxide, aluminum oxide, CARTASOL® dyes (cationic dyes, available from Clariant Services) in liquid and/or granular form (e.g., CARTASOL® Brilliant Yellow K-6G liquid, CARTASOL® Yellow K-4GL liquid, CARTASOL® Yellow K-GL liquid, CARTASOL® Orange K-3GL liquid, CARTASOL® Scarlet K-2GL liquid, CARTASOL® Red K-3BN liquid, CARTASOL® Blue K-5R liquid, CARTASOL® Blue K-RL liquid, CARTASOL® Turquoise K-RL liquid/granules, CARTASOL® Brown K-BL liquid), FASTUSOL® dyes (an auxochrome, available from BASF) (e.g., Yellow 3GL, Fastusol C Blue 74L), and the like, any derivative thereof, and any combination thereof.

In some embodiments, pigments and dyes suitable for use in conjunction with a cellulose ester plastic described herein may be food-grade pigments and dyes. Examples of food-grade pigments and dyes may, in some embodiments, include, but are not limited to, plant dyes, vegetable dyes, titanium dioxide, and the like, and any combination thereof.

Antioxidants may, in some embodiments, mitigate oxidation and/or chemical degradation of a cellulose ester plastic described herein during storage, transportation, and/or implementation. Antioxidants suitable for use in conjunction with a cellulose ester plastic described herein may, in some embodiments, include, but are not limited to, anthocyanin, ascorbic acid, glutathione, lipoic acid, uric acid, resveratrol, flavonoids, carotenes (e.g., beta-carotene), carotenoids, tocopherols (e.g., alpha-tocopherol, beta-tocopherol, gamma-tocopherol, and delta-tocopherol), tocotrienols, tocopherol esters (e.g., tocopherol acetate), ubiquinol, gallic acids, melatonin, secondary aromatic amines, benzofuranones, hindered phenols, polyphenols, hindered amines, organophosphorus compounds, thioesters, benzoates, lactones, hydroxylamines, butylated hydroxytoluene (“BHT”), butylated hydroxyanisole (“BHA”), hydroquinone, and the like, and any combination thereof.

In some embodiments, antioxidants suitable for use in conjunction with a cellulose ester plastic described herein may be food-grade antioxidants. Examples of food-grade antioxidants may, in some embodiments, include, but are not limited to, ascorbic acid, vitamin A, tocopherols, tocopherol esters, beta-carotene, flavonoids, BHT, BHA, hydroquinone, and the like, and any combination thereof.

The plasticized cellulose ester product of the present disclosure can be formed into any suitable polymer article using any technique known in the art. For instance, polymer articles can be formed from the polymer product through extrusion, injection molding, blow molding, and the like.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. A process for producing a cellulose ester product comprising:
combining cellulose ester particles with a plasticizer and a wetting agent; and
melt processing the cellulose ester, plasticizer and wetting agent mixture into a plasticized cellulose ester product, the wetting agent vaporizing during melt processing.

2. A process as defined in claim 1, wherein the wetting agent comprises a liquid having a boiling point of less than about 100° C. and greater than about 40° C.

3. A process as defined in claim 1, wherein the cellulose ester particles are soluble in the wetting agent.

4. A process as defined in claim 1, wherein the wetting agent comprises acetone.

5. A process as defined in claim 1, wherein the wetting agent comprises dimethyl carbonate.

6. A process as defined in claim 1, wherein the cellulose ester particles are in the form of flakes or a granulated flake.

7. A process as defined in claim 1, wherein greater than about 50% by weight of the cellulose ester particles have a particle size of greater than 850 microns when measured according to a sieve test.

8. A process as defined in claim 1, wherein the cellulose ester particles contain moisture in an amount greater than about 2% by weight when combined with the plasticizer.

9. A process as defined in claim 1, wherein the cellulose ester particles, the plasticizer, and the wetting agent are melt processed by being fed through an extruder, the cellulose ester particles, the plasticizer, and the wetting agent being added to the extruder at different locations on the extruder.

10. A process as defined in claim 1, wherein the cellulose ester particles have not been ground or subjected to a drying step to remove moisture prior to being combined with the plasticizer and wetting agent.

11. A process as defined in claim 1, wherein the wetting agent is free of volatile organic compounds.

12. A process as defined in claim 1, wherein the wetting agent comprises cyclohexinone, methyl ethyl ketone, or ethyl acetate.

13. A process as defined in claim 1, wherein the wetting agent is added to the cellulose ester particles in an amount from about 0.05% by weight to about 10% by weight based on the weight of the cellulose ester particles.

14. A process as defined in claim 1, wherein the plasticizer is preheated prior to contact with the cellulose ester particles.

15. A process as defined in claim 1, wherein the cellulose ester and plasticizer are melt processed into pellets or strands.

16. A process as defined in claim 1, wherein the plasticizer comprises tris(clorisopropyl) phosphate, tris(2-chloro-1-methylethyl) phosphate, glycerin, monoacetin, triethyl citrate, acetyl triethyl citrate, a phthalate, an adipate, polyethylene glycol, triacetin, diacetin, trimethyl phosphate, triethyl phosphate, tributyl phosphate, triphenyl phosphate, tributyl-o-acetyl citrate, dibutyl tartrate, ethyl o-benzoylbenzoate, n-ethyltoluenesulfonamide, o-cresyl p-toluenesulfonate, aromatic diol, a substituted aromatic diol, an aromatic ether, tripropionin, tribenzoin, glycerin esters, glycerol tribenzoate, glycerol acetate benzoate, polyethylene glycol, a polyethylene glycol ester, a polyethylene glycol diester, di-2-ethylhexyl polyethylene glycol ester, a glycerol ester, diethylene glycol, polypropylene glycol, a polyglycoldiglycidyl ether, dimethyl sulfoxide, N-methyl pyrollidinone, propylene carbonate, a C1-C20 dicarboxylic acid ester, di-butyl maleate, di-octyl maleate, resorcinol monoacetate, catechol, catechol esters, phenols, epoxidized soy bean oil, castor oil, linseed oil, epoxidized linseed oil, difunctional glycidyl ether based on polyethylene glycol, an alkyl lactone, a phospholipid, 2-phenoxyethanol, acetylsalicylic acid, acetaminophen, naproxen, imidazole, triethanol amine, benzoic acid, benzyl benzoate, salicylic acid, 4-hydroxybenzoic acid, propyl-4-hydroxybenzoate, methyl-4-hydroxybenzoate, ethyl-4-hydroxybenzoate, benzyl-4-hydroxybenzoate, glyceryl tribenzoate, neopentyl dibenzoate, triethylene glycol dibenzoate, trimethylolethane tribenzoate, butylated hydroxytoluene, butylated hydroxyanisol, sorbitol, xylitol, ethylene diamine, piperidine, piperazine, hexamethylene diamine, triazine, triazole, pyrrole, and mixtures thereof.

17. A process as defined in claim 1, wherein the plasticizer comprises triacetin, polyethylene glycol, or mixtures thereof.

18. A process as defined in claim 1, wherein the cellulose ester is present in the product in an amount of from about 15% to about 95% by weight and the plasticizer is present in the product in an amount of from about 3% to about 40% by weight.

19. A process as defined in claim 1, wherein the cellulose ester comprises primarily cellulose diacetate.

20. A process as defined in claim 1, wherein the cellulose ester product further comprises an antioxidant, a stabilizer, an organic acid, an oil, filler particles, glass fibers, a pigment, a bio-based polymer other than the cellulose ester, a biodegradable enhancer, a foaming agent, or mixtures thereof.

21. A process as defined in claim 1, wherein the cellulose ester product further comprises a mineral filler, the mineral filler comprising talc, calcium carbonate, a metal oxide, mica, or mixtures thereof.

22. A process as defined in claim 1, wherein the cellulose ester product further comprises a coloring agent, the coloring agent comprising an organic dye, an inorganic dye, a pigment, or mixtures thereof.
